(19) United States
(12) Patent Application Publication
(10) Pub. No.: US 2002/0087319 A1
(43) Pub. Date: Jul. 4, 2002

(54) Portable electronic voice recognition device capable of executing various voice activated commands and calculations associated with aircraft operation by means of synthesized voice response

(76) Inventor: Marc C. Stephenson, Waukegan, IL (US)

Correspondence Address: Charles F. Meroni, Jr., Meroni & Meroni, A Professional Corporation, P. O. Box 309, Barrington, IL, 60011, US

(21) Appl. No.: 09/754,517

(22) Filed: Jan. 4, 2001

(51) Int. Cl. G10L 21/00

(52) U.S. Cl. 704/270

(57) ABSTRACT

This invention concerns a portable electronic voice recognition device capable of executing various voice activated commands and calculations associated with aircraft operation by means of synthesized voice response. The portable electronic voice recognition device comprises an integrated circuit capable of voice recognition and speech synthesis, an input interface device connecting to said integrated circuit, an output interface device connecting to said integrated circuit, a data transfer interface connecting to said integrated circuit, and a housing. The housing has the integrated circuit, the input interface device, the output interface device and the data transfer interface disposed therein

### BACKGROUND OF THE INVENTION

1. Field of the Invention

The present invention relates to a computerized voice activated aircraft checklist system. More specifically, my invention is primarily intended for providing a computerized voice recognition aircraft checklist system that capable of executing various voice activated commands and calculations associated with aircraft operation by means of synthesized voice response.

2. Description of the Prior Art

A pilot is required to accurately determine and constantly be aware of the current aircraft status, including location, direction, speed, altitude, attitude, and the rate of change of all of the above. Printed checklists have been used extensively in aircraft operation. Printed checklists are useful tools in helping the pilots with the operation of the aircrafts. However, the existing printed checklists are not perfect. When a pilot is following a printed checklist to do an operation checklist, the pilot has to look at the printed checklist from time to time. Therefore, the existing printed checklist obviously distracts the pilot from focusing on the aircraft operation. In order to solve this problem and provide a means for a pilot to focus on the aircraft operation all the time, rather than look at a printed checklist from time to time, a lot of inventions have been made in order to minimize or solve this problem.

In U.S. Pat. No. 4,048,453, which issued to Harshaw et al., discloses a Computerized Checklist with Predetermined Sequences of Sublists Which Automatically Returns to Skipped Checklists. In this patent, a computerized checklist system is provided for ensuring safe and consistent operation of sophisticated equipment such as aircraft, milling machines, and other complicated systems. The checklist system includes a microprocessor having an erasable programmable read only memory for storing alphanumeric data in the form of checklist items. A display panel is provided for visual output of the checklist items, and a voice synthesizer is provided for audible output of the checklist items. The system is designed to accommodate checklists in the form of a number of sublists, with each sublist comprising checklist items in a predetermined sequence. A control panel is provided to initiate the checklist sequence, progress through the sequence of items, skip items in the sequence, return to skipped items automatically at the end of the sequence, and exit the sequence at any time upon command.

In U.S. Pat. No. 5,454,074, which issued to Hartel et al., discloses an electronic Checklist System. This patent discloses a computer-based electronic checklist system that is interfaced with a crew alert system. The system provides both normal checklists (i.e., checklists for use during routine operation of the airplane) and non-normal checklists for use with crew alert messages that are supplied by the crew alert system. Non-normal checklists that are not associated crew alert messages are also provided. Status indicators are provided to indicate the completion state of non-normal checklists; the completion state of normal checklists, and, when applicable, the existence of a normal checklist that has not yet been used during that particular flight program. Checklist line items of each checklist are displayed in a manner that distinguishes between closed-loop items (i.e., checklist items for which the system operator need not respond); and open-loop line items (i.e., items requiring an operator response). Visual indication also is provided as to the completion state of each open-loop and closed-loop checklist line item. Accessing a desired normal or non-normal checklist is accomplished by using one of two command buttons. Operational notes encountered during operation of the system can be displayed at any time by actuating a single command button and a system menu screen listing the normal and non-normal checklists is displayed by actuating a single command button.

In U. S. Pat. No. 5,475,594, which issued to Oder et al., discloses a Method and Device for Assisting the Piloting of an Aircraft from a Voluminous Set of Memory-Stored Documents. This patent provides a method for assisting the piloting of an aircraft from a voluminous set of memory-stored documents which uses a processor associated with a terminal comprising a screen and control and data entry keys and with memories containing useful information for operating a flight, the processor being connected to other items of equipment of the aerodyne. The method comprises storing of information in a data base and supplying first exploitation functions of this information, real-time acquisition by the processor of an event relative to the current situation of the aerodyne and analyzing the new situation generated by the occurrence of this event, preselecting the information in the data base best adapted to the new situation, and classifying same by order of relevance, supplying second exploitation functions of the preselected information, selection and exploitation, by the operator, of one of the exploitation functions. The method applies in particular to the civil and commercial aviation.

In U. S. Pat. No. 5,689,419, which issued to Massat, discloses an Apparatus Including Computer Control and Voice Repetition of Digital Setting Message. The control apparatus disclosed by this patent is suitable for use on airplanes. It has a digital computer, order-issuing devices for issuing settings in the form of digital messages including data plus a label number identifying the message in a standardized format. Actuators implement the settings under the control of the computer. The apparatus also has decoders which decode the digital messages issued by the order-issuing devices, typically in ARINC form, and a voice synthetizer provides a voice announcement specifying in the clear the setting as actually issued.

In U. S. Pat. No.6,038,948, which issued to Briffe et al., discloses an apparatus and Method for Aircraft Monitoring and Control Including Electronic Check-List Management. The invention discloses a system for managing check lists solely by operation of a four-position rocker switch having a center return position. The system includes check list data organized into three levels and automatically displayed upon occurrence of an abnormal condition.

However, none of the invention provides pilots with a portable electronic voice recognition device capable of executing various voice activated commands and calculations associated with aircraft operation by means of synthesized voice response.

What is needed then is a portable electronic voice recognition device capable of executing various voice activated commands and calculations associated with aircraft operation by means of synthesized voice response.

Accordingly, it is a principal object of my invention to provide an electronic voice recognition device capable of executing various voice activated commands associated with aircraft operation by means of synthesized voice response.

It is a further object of my invention to provide an electronic voice recognition device capable of executing various voice activated calculations associated with aircraft operation by means of synthesized voice response.

It is a still further object of my invention to provide a portable electronic voice recognition device capable of executing various voice activated commands and calculations associated with aircraft operation by means of synthesized voice response.

Other objects of my invention, as well as particular features, elements, and advantages thereof, will be elucidated in, or apparent from, the following description and the accompanying drawing figures.

### SUMMARY OF THE INVENTION

According to my present invention I have provided a portable voice recognition device capable of executing various voice activated commands and calculations associated with aircraft operation by means of synthesized voice response.

In the preferred embodiment, I have provided a portable electronic voice recognition device capable of executing various voice activated commands and calculations associated with aircraft operation by means of synthesized voice response. The portable electronic voice recognition device comprises an integrated circuit capable of voice recognition and speech synthesis, an input interface device connecting to the integrated circuit, an output interface device connecting to the integrated circuit, a data transfer interface connecting to the integrated circuit, and a housing. The housing has the integrated circuit, the input interface device, the output interface device and the data transfer interface disposed therein.

The integrated circuit of the portable electronic voice recognition device further comprises at least a pre-amplifier, an analog to digital converter, a digital to analog converter, an analog controller, a pulse width modulator, an oscillator's, a central processing unit, an external memory interface, a speech processing unit, a timer, an internal random access memory, and a data storage. The data storage is capable of storing and being uploaded with different databases and software programs through the I/O or communication port by the computer. The integrated circuit of he portable electronic voice recognition device is capable of continuous listening and word spotting.

The portable electronic voice recognition device is capable of integrated into the aircraft's communication system without interfering with regular operation of aircraft communications. The portable electronic voice recognition device is operable only when the input interface device is connected to a voice inputting device. The portable electronic voice recognition device is capable of being activated by a pre-programmed signal. The portable electronic voice recognition device is capable of providing a pre-programmed output synthesized voice prompt in responding to an input voice prompt, the pre-programmed output synthesized voice prompt being different for different aircrafts. The portable electronic voice recognition device waits for an input voice prompt before providing next pre-programmed output synthesized voice prompt. The portable electronic voice recognition device is capable of operating either being connected to or disconnected from the aircraft's communication system. The portable electronic voice recognition device is capable of functioning as a flight computer.

### DESCRIPTION OF THE DRAWINGS

Other features of my invention will become more evident from a consideration of the following detailed description of my patent drawings, as follows:

FIG. 1 is a portable electronic voice recognition device capable of executing various voice activated commands and calculations associated with aircraft operation by means of synthesized voice response;

FIG. 2 is a detailed structure of the integrated circuit;

FIG. 3 is a portable electronic voice recognition device integrated with the aircraft's communication system;

FIG. 4 is a flow diagram of performing voice activated commands by the portable electronic voice recognition device;

FIG. 5 is a flow diagram of performing voice activated calculations by the portable electronic voice recognition device;

FIG. 6 is a portable electronic voice recognition device connected to both the aircraft's communication system and the pilot's headset; and

FIG. 7 is a working prototype of the portable electronic voice recognition device.

### DETAILED DESCRIPTION OF THE PREFERRED EMBODIMENT

Referring now to the drawings, the present invention concerns a portable electronic voice recognition device capable of executing various voice activated commands and calculations associated with aircraft operation by means of synthesized voice response.

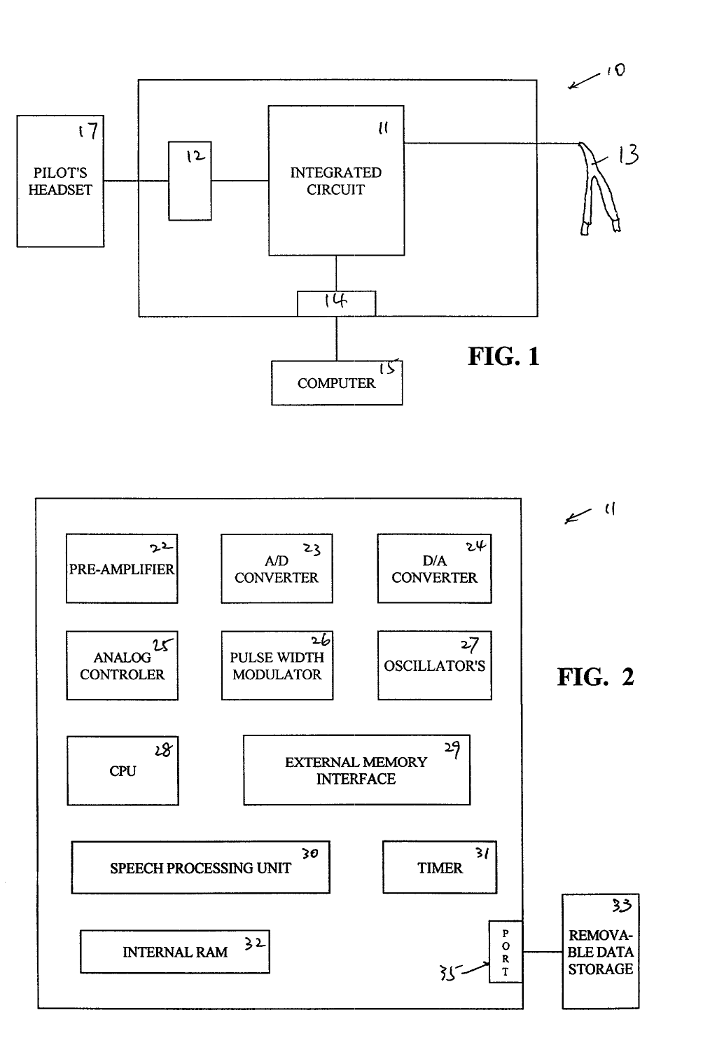

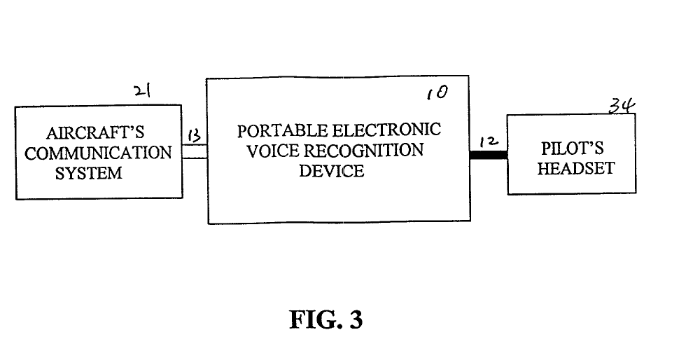

Referring now to FIGS. 1 and 3, a portable electronic voice recognition device 10 capable of executing various voice activated commands and calculations associated with aircraft operation by means of synthesized voice response. The portable electronic voice recognition device 10 comprises an integrated circuit 11 capable of voice recognition and speech synthesis, a set of input jacks 12 capable of connecting to a pilot's headset, a set of output plug 13 capable of connecting to an aircraft's communication system 21, an I/O or communication port 14 capable of connecting to a computer 15, and a housing 16. The housing 16 has the integrated circuit 11, the set of input jacks 12, the set of output plugs 13 and the I/O or communication port 14 disposed therein. All the set of input jacks 12, the set of output plugs 13 and the I/O or communication port 14 connect to the integrated circuit 11. In the preferred embodiment, the input jacks 12 can be any kind of input interface capable of effectively gathering input voice signal. The output plugs 13 can be any kind of output interface capable of outputting and receiving two-way radio signal to aircraft's communication system 21. The I/O or communication port 14 can be any kind of connections capable of inputting/outputting data from/to a computer 15.

Referring now to FIG. 2, the integrated circuit 11 further comprises at least a pre-amplifier 22, an analog to digital converter 23, a digital to analog converter 24, an analog controller 25, a pulse width modulator 26, an oscillator's 27, a central processing unit 28, an external memory interface 29, a speech processing unit 30, a timer 31, an internal random access memory 32, and a data storage 33. The data storage 33 can be a data storage integrated within the integrated circuit 11 or a removable data storage connecting to the integrated circuit 11 through a port 35. The data storage 33 is capable of storing and being uploaded with different databases and software programs.

Referring now to FIGS. 1 and 3, the portable electronic voice recognition device 10 connects communication system 21 through the set of output plug 13, and to pilot's headset through the set of input jacks 12. The portable electronic voice recognition device 10 is capable of being integrated into the aircraft's communication system 21 without interfering with regular operation of aircraft's communications. No matter the portable electronic voice recognition device 10 is on or off, the pilot is capable of communicating with aircraft's communication system 21. The portable electronic voice recognition device 10 is operable only when the set of input jacks 12 are connected to a pilot's headset 17 that comprises of a headphone and a microphone.

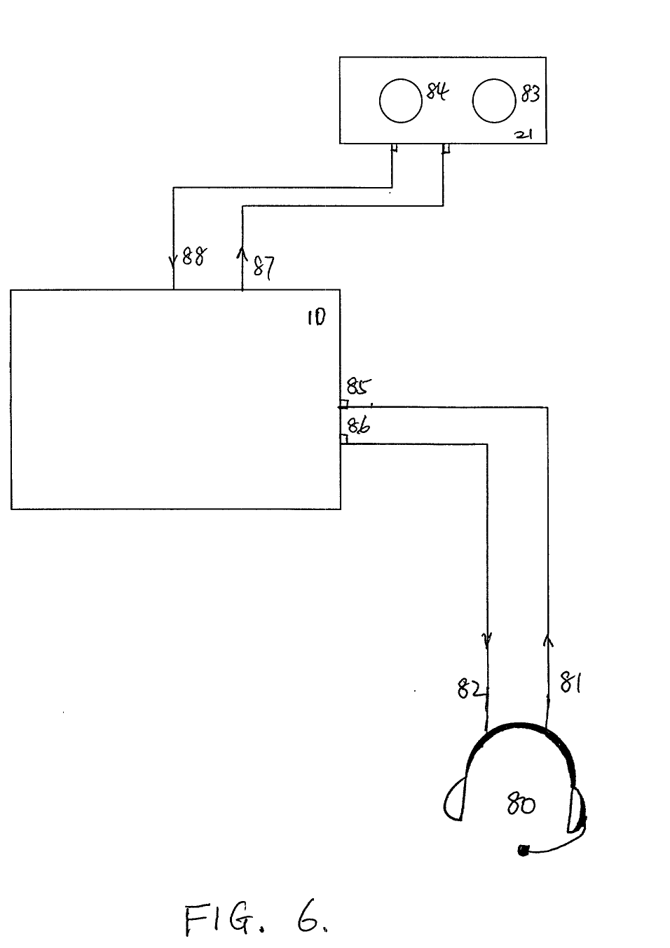

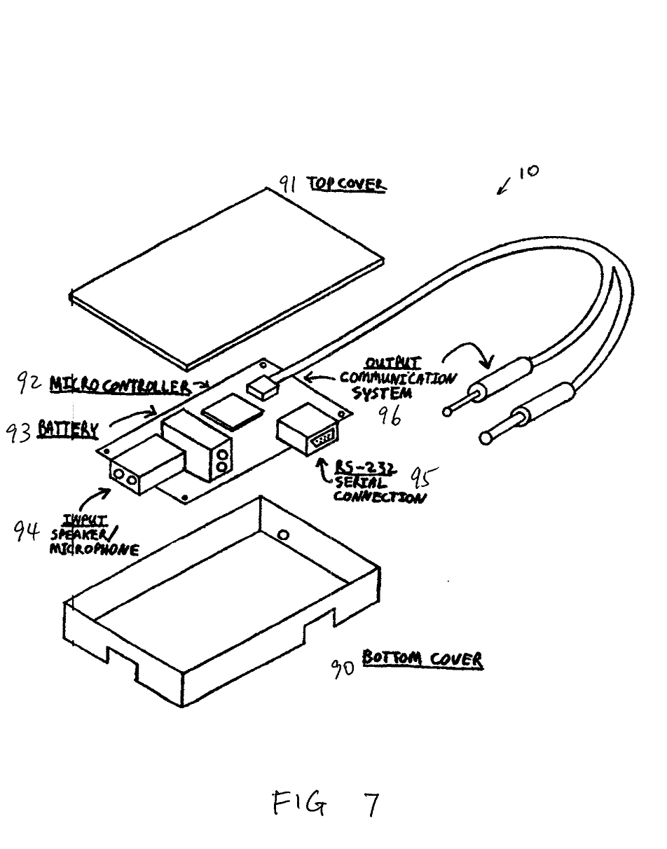

Referring now to FIG. 6, which provides the details of the connections among the pilot's headset 80, the potable electronic voice recognition device 10, and aircraft's communication system 21. The pilot's headset 80 can be connected to aircraft's communication system by plugging microphone lead wire 81 into microphone jack 83 of the aircraft's communication system 21 and headphone lead wire 82 into headphone jack 84 of the aircraft's communication system. The pilot's headset 80 can also be connected to aircraft's communication system through the portable electronic voice recognition device 10 as well. The pilot's headset 80 can be connected to the portable electronic voice recognition device 10 by plugging microphone lead wire 81 into microphone jack 85 of the portable electronic voice recognition device 10 and headphone lead wire 82 into headphone jack 86 of the portable electronic voice recognition device 10. The portable electronic voice recognition device 10 can then be connected to the aircraft's communication system 21 by plugging the microphone lead wire 87 of the portable electronic voice recognition device 10 into microphone jack 21 of the aircraft's communication system 21 and headphone lead wire 88 of the portable electronic voice recognition device 10 into headphone jack 84 of the aircraft's communication system 21.

Referring now to FIG. 7, which is a prototype of portable electronic voice recognition device 10. The portable electronic voice recognition device 10 includes a bottom cover 90 and a top cover 91. Inside the bottom cover 90 and top cover 91 is a micro controller 92. The micro controller 92 includes a battery 93, an input speaker/microphone 94, a RS-232 serial connection 95, and an output communication system 96.

The portable electronic voice recognition device 10 is idle until it is activated by a specific input voice prompt, which is pre-programmed into the portable electronic voice recognition device 10. The pre-programmed input voice prompt can be “start”, “initiate”, or like. The portable electronic voice recognition device 10 can also be activated by an on/off switch. However, no matter the portable electronic voice recognition device 10 is activated by specific input voice prompt or an on/off switch, it will not interrupt normal operation of aircraft's communication system 21 after it is integrated into the aircraft's communication system 21.

The portable electronic voice recognition device 10 is capable of providing a pre-programmed output synthesized voice prompt in responding to an input voice prompt. The pre-programmed output synthesized voice prompt can be either a single output synthesized voice prompt or a series of output synthesized voice prompts. The pre-programmed output synthesized voice prompt is different for different aircrafts. After the portable electronic voice recognition device 10 is activated, the portable electronic voice recognition device 10 waits for an input voice prompt before providing next pre-programmed output synthesized voice prompt. This feature provides the pilot with enough time to perform the checklist following the synthesized voice instruction from the portable electronic voice recognition device 10 before going to the next step. In case that the pilot does not understand the instruction from the portable electronic voice recognition device 10, the pilot can instruct the portable electronic voice recognition device 10 to repeat the instruction. The portable electronic voice recognition device 10 is capable of interacting with the instruction from the pilot. The portable electronic voice recognition device 10 will repeat pilot's instruction and confirm the instruction from the pilot before moving down the checklist to provide pilot with more instructions. The step of repeating the instruction provides pilot with an opportunity to confirm the accuracy of the instruction received by the portable electronic voice recognition device 10.

One of the significant features of the portable electronic voice recognition device 10 is its capability of operating either being connected to or disconnected from the aircraft's communication system 21. Always before taking off, pilot needs to perform some aircraft checklist outside the aircraft. Pilot can plug his headset 34 into the portable electronic voice recognition device 10 and bring the portable electronic voice recognition device 10 outside the aircraft to perform the checklist. The portable electronic voice recognition device 10 is still capable of providing the pilot with all the information the pilot needs to perform various checklists.

The portable electronic voice recognition device 10 is also capable of performing the same as an E6-B flight computer. The portable electronic voice recognition device 10 is capable of calculating ground speed, course heading, wind correction angle, fuel consumption, leg time, distance flown, weight and balance, pressure density altitude, cross wind component and miscellaneous conversions based on various input voice prompts and responding with various output synthesized voice prompts.

The integrated circuit 11 of the portable electronic voice recognition device 10 is capable of continuous listening and word spotting. The integrated circuit 11 can be either speaker dependent or speaker independent. In a speaker dependent situation, the portable electronic voice recognition device 10 needs to have enough data storage capacity or memory to process the voice. In a speaker independent situation, the portable electronic voice recognition device 10 needs to have less data storage capacity or memory as to that of a speaker dependent situation.

In the preferred embodiment, the portable electronic voice recognition device 10 is powered by battery. The portable electronic voice recognition device 10 can also be powered by some power sources other than battery.

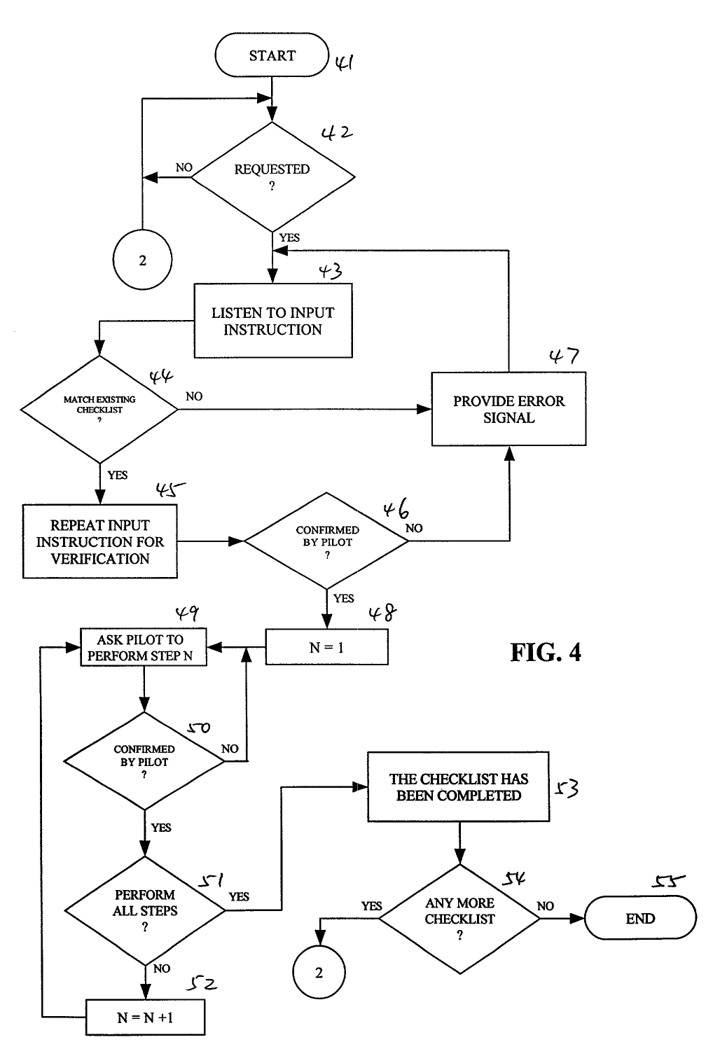

Referring now to FIG. 4, which provides a flow diagram of executing various voice activated commands by the portable electronic voice recognition device 10. A procedure starts at block 41, and proceeds immediately to block 42. At block 42, a check is conducted to determine if an application request for voice activated checklist is detected. If NO, the procedure continues looping awaiting an application request for voice activated checklist. If YES, the procedure proceeds to block 43. At block 43, the procedure listens to input instructions from the pilot. The portable electronic voice recognition device 10 is capable of continuous listening and word spotting. Therefore, there is no requirement for the pilot to respond to the portable voice recognition device 10 immediately. After the procedure gets input instructions from the pilot, it proceeds to block 44. At block 44, a check is conducted to determine if the inputted instruction matches the command for one of the existing checklists in the databases of the portable electronic voice recognition device 10. If NO, the procedure proceeds to block 47. At block 47, the portable electronic voice recognition device 10 provides the pilot with an output synthesized voice to inform the pilot that an error has occurred, and proceeds to block 43. Going back to block 44, if the inputted instruction matches the command for one of the existing checklists in the databases of the portable electronic voice recognition device 10, the procedure proceeds to block 45. At block 45, the procedure repeats the instruction from the pilot for pilot's confirmation, and proceeds to block 46. Since the portable electronic voice recognition device 10 will verify the instruction it got from the pilot before it proceeds to the checklist associated with the instruction, any inputting command error between the pilot and the portable electronic voice recognition device 10 can be detected and corrected immediately. At block 46, a check is conducted to determine if the pilot confirms the instruction repeated by the portable electronic voice recognition device 10. If NO, the procedure proceeds to block 47. Going back to block 46, if the pilot confirms the instruction repeated by the portable electronic voice recognition device 10, the procedure proceeds to block 48. At block 48, the procedure sets up a counter N, which equal 1, and proceeds to block 49. At block 49, the portable electronic voice recognition device 10 provides the pilot with a synthesized voice command of step N of the checklist, and proceeds to block 50. Since the N is 1, the portable electronic voice recognition device 10 provides the pilot with a synthesized voice command of step one of the checklist. At block 50, a check is conducted to determine if the pilot confirms that the step has been completed and is waiting for the next step down the checklist. If NO, the procedure proceeds to block 49, and the portable electronic voice recognition device 10 repeats step N of the checklist. Going back to block 50, if the pilot confirms that the step has been completed and is waiting for the next step down the checklist, the procedure proceeds to block 51. At block 51, a check is conducted to determine if all the steps of the checklist have been completed by the pilot. If NO, the procedure proceeds to block 52. At block 52, the procedure increases N by 1, and proceeds to block 49. Going back to block 51, if all the steps of he checklist have been completed by the pilot, the procedure proceeds to block 53. At block 53, the portable electronic voice recognition device 10 tells the pilot that the checklist has been completed, and proceeds to block 54. At block 54, a check is conducted to determine if one more checklist is requested by the pilot. If YES, the procedure proceeds to block 42. Going back to block 54, if no more checklist is requested by the pilot, the procedure proceeds to block 55 and ends right there.

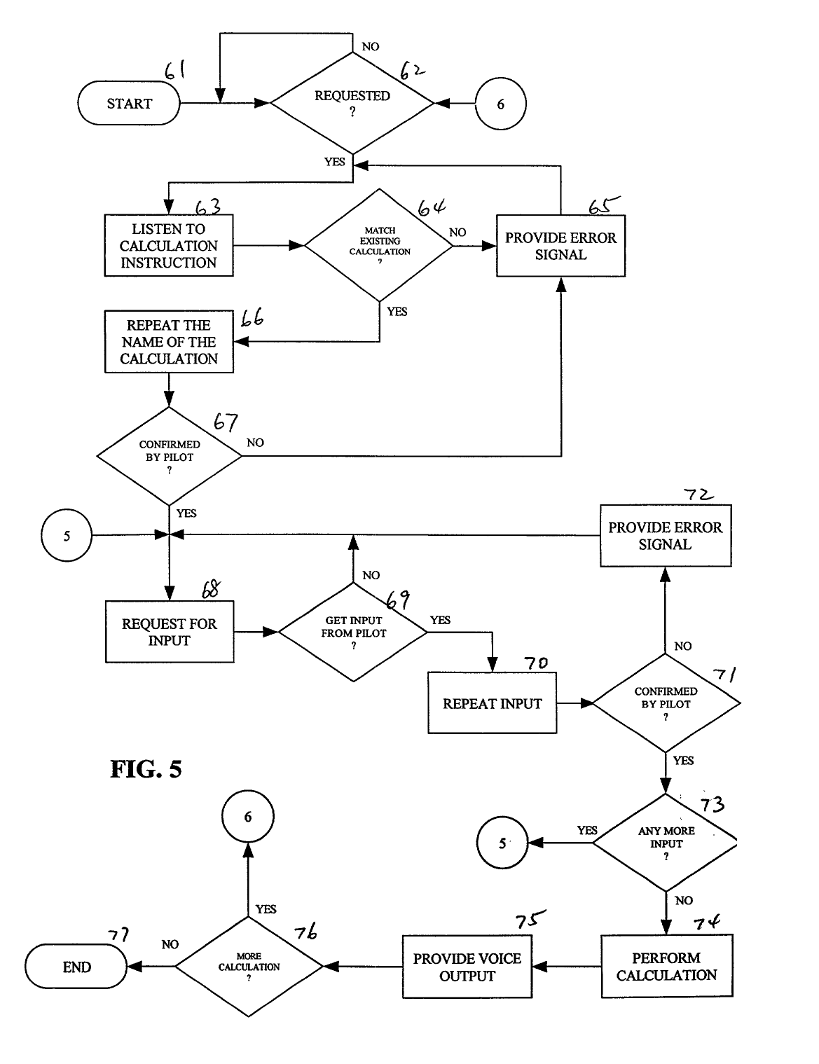

Referring now to FIG. 5, which provides a flow diagram of executing various voice activated calculations by the portable electronic voice recognition device 10. A procedure starts at block 61, and proceeds immediately to block 62, where a check is conducted to determine if an application request for voice activated calculations is received by the portable electronic voice recognition device 10. If NO, the procedure continues looping awaiting an application request for voice activated calculations by the portable electronic voice recognition device 10. If YES, the procedure proceeds to block 63. At block 63, the procedure listens to the calculation instruction from the pilot, and proceeds to block 64. At block 64, a check is conducted to determine if the instruction received by the portable electronic voice recognition device 10 matches one of the existing calculations in the database of the portable electronic voice recognition device 10. If NO, the procedure proceeds to block 65. At block 65, the portable electronic voice recognition device 10 provides the pilot with a synthesized voice telling the pilot that an error has occurred. Going back to block 64, if the instruction received by the portable electronic voice recognition device matches one of the existing calculations in the database of the portable electronic voice recognition device 10, the procedure proceeds to block 66. At block 66, the portable electronic voice recognition device 10 repeats the name of the calculation, and proceeds to block 67. At block 67, a check is conducted to determine if the kind of calculation repeated by the portable electronic voice recognition device 10 is confirmed by the pilot. If NO, the procedure proceeds to block 65. Going back to block 67, if the kind of calculation repeated by the portable electronic voice recognition device 10 is confirmed by the pilot, the procedure proceeds to block 68. At block 68, the portable electronic voice recognition device 10 asks the pilot for input as to the required information for the calculation, and proceeds to block 69. At block 69, a check is conducted to determine if an input has been provided by the pilot and received by the portable electronic voice recognition device 10. If NO, the procedure proceeds to block 68. If an input has been provided by the pilot and received by the portable electronic voice recognition device 10, the procedure proceeds to block 70. At block 70, the portable electronic voice recognition device repeats the input information it got from the pilot, and proceeds to block 71. At block 71, a check is conducted to determine if the information repeated by the portable electronic voice recognition device 10 is confirmed by the pilot. If NO, the procedure proceeds to block 72. At block 72, the portable electronic voice recognition device 10 provides the pilot with an error signal, and proceeds to block 68. Going back to block 71, if the information repeated by the portable electronic voice recognition device 10 is confirmed by the pilot, the procedure proceeds to block 73. At block 73 a check is conducted to determine if the portable electronic voice recognition device 10 needs more information from the pilot in order to accomplish the calculation. If YES, the procedure proceeds to block 68. Returning to block 73, if the portable electronic voice recognition device 10 gets all the information it needs to accomplish the calculation, the procedure proceeds to block 74. At block 74, the portable electronic voice recognition device 10 performs the calculation based on the information it has, and proceeds to block 75. At block 75, the portable electronic voice recognition device 10 provides the pilot with a synthesized voice output informing the pilot the result of the calculation, and proceeds to block 76. At block 76, a check is conducted to determine if more calculation is requested by the pilot. If YES, the procedure proceeds to block 62. Going back to block 76, if no more calculation is requested by the pilot, the procedure proceeds to block 77 and ends right there.

Following are the interactive procedures of one of the checklists that the portable electronic voice recognition device 10 is capable of performing.

The Pilot speaks into the microphone of his/her headset and says, “Perform Preflight Inspection”.

The Pilot's Pal will then confirm the request by responding, “Do you want to start the Preflight Inspection?”

The Pilot responds, “Yes”.

The Pilot's Pal then accesses the Preflight Inspection that is stored in memory and begins to speak the first step, “Pilot's operating handbook, available in the airplane?”

The pilot would then check to see if the operating handbook is available in the airplane and if it were, he/she would respond to the Pilot's Pal by saying, “Check”. This process is continued until all steps of the preflight inspection are completed.

Followings are the interactive procedures for some of the calculations that the portable electronic voice recognition device 10 is capable of performing.

The pilot speaks into his/her microphone and says, “Calculate ground speed!”

The portable electronic voice recognition device 10 responds by saying, “Do you want to calculate ground speed?”

The pilot responds, “Yes”.

The portable electronic voice recognition device 10 then responds by asking, “What is the distance?”

The pilot responds, “Fifteen”.

The portable electronic voice recognition device 10 responds, “Did you say fifteen?”

The pilot responds, “Yes”.

The portable electronic voice recognition device 10 then responds by asking, “What is the time?”

The pilot responds, “Seven minutes and thirty seconds”.

The portable electronic voice recognition device 10 responds, “Did you say Seven minutes and thirty seconds?”

The pilot responds, “Yes”.

The portable electronic voice recognition device 10 responds, “Your ground speed is one hundred twenty”.

The pilot then asks, “Calculate leg time”.

The portable electronic voice recognition device 10 responds by saying, “Do you want to calculate leg time?”

The pilot responds, “Yes”.

The portable electronic voice recognition device 10 then responds by asking, “What is the distance?”

The pilot responds, “Seventy five”.

The portable electronic voice recognition device 10 responds, “Did you say Seventy five?”

The pilot responds, “Yes”

The portable electronic voice recognition device 10 then responds by asking, “What is the ground speed?”

The pilot responds, “One hundred twenty”.

The portable electronic voice recognition device 10 responds, “Did you say one hundred twenty?”

The pilot responds, “Yes”.

The portable electronic voice recognition device 10 responds, “Your leg time is thirty seven minuets and thirty seconds”.

The pilot then asks, “Calculate fuel required”.

The portable electronic voice recognition device 10 responds by saying, “Do you want to calculate fuel required?”

The pilot responds, “Yes”.

The portable electronic voice recognition device 10 then responds by asking, “What is the time?”

The pilot responds, “Thirty seven minuets and thirty seconds“.

The portable electronic voice recognition device 10 responds, ”Did you say thirty seven minuets and thirty seconds?”

The pilot responds, “Yes”.

The portable electronic voice recognition device 10 then responds by asking, “What is the fuel burn per hour?”

The pilot responds, “Nine”.

The portable electronic voice recognition device 10 responds, “Did you say nine?”

The pilot responds, “Yes”.

The portable electronic voice recognition device 10 responds, “Your fuel required is five point six gallons”.

The portable electronic voice recognition device 10 would then speak the next step of the Preflight Inspection. This would continue until all of the steps of the Preflight Inspection have been communicated to the pilot.

Hence, the present invention provides an electronic voice recognition device capable of executing various voice activated commands associated with aircraft operation by means of synthesized voice response.

The present invention also provides an electronic voice recognition device capable of executing various voice activated calculations associated with aircraft operation by means of synthesized voice response.

The present invention further provides a portable electronic voice recognition device capable of executing various voice activated commands and calculations associated with aircraft operation by means of synthesized voice response.

As various possible embodiments may be made in the above invention for use for different purposes and as various changes might be made in the embodiments and methods above set forth, it is understood that all of the above matters here set forth or shown in the accompanying drawings are to be interpreted as illustrative and not in a limiting sense.

I claim:

1. A portable electronic voice recognition device capable of executing various voice activated commands and calculations associated with aircraft operation by means of synthesized voice response, said portable electronic voice recognition device comprising:
an integrated circuit capable of voice recognition and speech synthesis, said integrated circuit further comprising at least a pre-amplifier, an analog to digital converter, a digital to analog converter, an analog controller, a pulse width modulator, an oscillator's, a central processing unit, an external memory interface, a speech processing unit, a timer, an internal random access memory, and a data storage, said data storage capable of storing and being uploaded with different software programs;
a set of input jacks capable of connecting to a microphone, said set of input jacks connecting to said integrated circuit;
a set of output plug capable of connecting to an aircraft's communication system, said set of output plugs connecting to said integrated circuit;
an I/O or communication port capable of connecting to a computer, said I/O or communication port connecting to said integrated circuit;
and a housing, said housing having said integrated circuit, said set of input jacks, said set of output plugs and said I/O or communication port disposed therein.

2. The portable electronic voice recognition device in claim 1 is capable of integrated into said aircraft's communication system without interfering with regular operation of aircraft's communications.

3. The portable electronic voice recognition device in claim 1 is operable only when said set of input jacks are connected to a voice inputting device, said voice inputting device being headphone or microphone.

4. The portable electronic voice recognition device in claim 1 is capable of being activated by an input voice prompt.

5. The portable electronic voice recognition device in claim 1 is capable of providing a pre-programmed output synthesized voice prompt in responding to an input voice prompt, said pre-programmed output synthesized voice prompt being a single output synthesized voice prompt or a series of output synthesized voice prompts, said pre-programmed output synthesized voice prompt being different for different aircrafts.

6. The portable electronic voice recognition device in claim 1 waits for an input voice prompt before providing next pre-programmed output synthesized voice prompt.

7. The portable electronic voice recognition device in claim 1 is capable of operating either being connected to or disconnected from said aircraft's communication system.

8. The portable electronic voice recognition device in claim 1 is capable of functioning as an E6-B flight computer, said E6-B flight computer capable of calculating ground speed, course heading, wind correction angle, fuel consumption, leg time, distance flown, weight and balance, pressure density altitude, cross wind component and miscellaneous conversions based on various input voice prompts and responding with various output synthesized voice prompts.

9. The portable electronic voice recognition device in claim 1, wherein said integrated circuit is capable of continuous listening and word spotting.

10. The portable electronic voice recognition device in claim 1, wherein said integrated circuit can be either speaker dependent or speaker independent.

11. The portable electronic voice recognition device in claim 1 is powered by battery.

12. A portable electronic voice recognition device capable of executing various voice activated commands and calculations associated with aircraft operation by means of synthesized voice prompts, said portable electronic voice recognition device comprising:
a set of input jacks capable of connecting to a microphone;
a set of output plugs capable of connecting to an aircraft's communication system;
an 1/O or communication port capable of connecting to a computer;
an integrated circuit capable of voice recognition and speech synthesis;
and a housing, said housing having said input jack, said output plug, said 1/O or communication port and said integrated circuit disposed therein.

13. The portable electronic voice recognition device in claim 12, wherein said integrated circuit further comprises at least a pre-amplifier, an analog to digital converter, a digital to analog converter, an analog controller, a pulse width modulator, an oscillator's, a central processing unit, an external memory interface, a speech processing unit, a timer, an internal random access memory, and a data storage, said data storage capable of storing various databases and software programs.

14. The portable electronic voice recognition device in claim 12 is capable of integrated into said aircraft's communication system without interfering with regular operation of aircraft communications.

15. The portable electronic voice recognition device in claim 12 is capable of accepting an input voice prompt and responding with an output synthesized voice prompt when said set of input jacks are connected to a voice inputting device, said voice inputting device being headphone or microphone.

16. The portable electronic voice recognition device in claim 12 is capable of providing a series of pre-programmed output synthesized voice prompts in responding to an input voice prompt, said pre-programmed output synthesized voice prompts being different for different aircrafts.

17. The portable electronic voice recognition device in claim 12 waits for an input voice prompt before providing next pre-programmed output synthesized voice prompt.

18. The portable electronic voice recognition device in claim 12, wherein said data storage is capable of being uploaded with different databases and software programs through said I/O or communication port.

19. The portable electronic voice recognition device in claim 12 is capable of functioning as a regular flight computer, said flight computer being capable of calculating ground speed, course heading, wind correction angle, fuel consumption, leg time, distance flown, weight and balance, pressure density altitude, cross wind component and miscellaneous conversions based on various input voice prompt inputs and responding with various output synthesized prompt outputs.

20. The portable electronic voice recognition device in claim 12, wherein said integrated circuit is capable of continuous listening and word spotting.

21. A portable electronic voice recognition device capable of executing various voice activated commands and calculations associated with aircraft operation by means of synthesized voice response, said portable electronic voice recognition device comprising:
an integrated circuit capable of voice recognition and speech synthesis;
an input interface device connecting to said integrated circuit;
an output interface device connecting to said integrated circuit;
a data transfer interface connecting to said integrated circuit; and
a housing, said housing having said integrated circuit, said input interface device, said output interface device and said data transfer interface disposed therein.

22. The portable electronic voice recognition device in claim 21, wherein said integrated circuit further comprising at least a pre-amplifier, an analog to digital converter, a digital to analog converter, an analog controller, a pulse width modulator, an oscillator's, a central processing unit, an external memory interface, a speech processing unit, a timer, an internal random access memory, and a data storage, said data storage capable of storing and being uploaded with different databases and software programs through said I/O or communication port by said computer.

23. The portable electronic voice recognition device in claim 21 is capable of integrated into said aircraft's communication system without interfering with regular operation of aircraft communications.

24. The portable electronic voice recognition device in claim 21 is operable only when said input interface device is connected to a voice inputting device.

25. The portable electronic voice recognition device in claim 21 is capable of being activated by a pre-programmed signal.

26. The portable electronic voice recognition device in claim 21 is capable of providing a pre-programmed output synthesized voice prompt in responding to an input voice prompt, said pre-programmed output synthesized voice prompt being different for different aircrafts.

27. The portable electronic voice recognition device in claim 21 waits for an input voice prompt before providing next pre-programmed output synthesized voice prompt.

28. The portable electronic voice recognition device in claim 21 is capable of operating either being connected to or disconnected from said aircraft's communication system.

29. The portable electronic voice recognition device in claim 21 is capable of functioning as a flight computer.

30. The portable electronic voice recognition device in claim 21, wherein said integrated circuit is capable of continuous listening and word spotting.

31. A portable electronic voice recognition device capable of executing various voice activated commands and calculations associated with aircraft operation by means of synthesized voice response, said portable electronic voice recognition device comprising:
an integrated circuit capable of voice recognition and speech synthesis;
an input interface device connecting to said integrated circuit;
an output interface device connecting to said integrated circuit;
a data transfer interface connecting to said integrated circuit; and
a housing, said housing having said integrated circuit, said input interface device, said output interface device and said data transfer interface disposed therein.

32. The portable electronic voice recognition device in claim 31, wherein said integrated circuit further comprising at least a pre-amplifier, an analog to digital converter, a digital to analog converter, an analog controller, a pulse width modulator, an oscillator's, a central processing unit, an external memory interface, a speech processing unit, a timer, an internal random access memory, and a data storage, said data storage capable of storing and being uploaded with different databases and software programs through said serial port by said computer.

33. The portable electronic voice recognition device in claim 32, wherein said integrated circuit is capable of continuous listening and word spotting.

34. The portable electronic voice recognition device in claim 33 is operable only when said input interface device is connected to a voice inputting device.

35. The portable electronic voice recognition device in claim 34 is capable of integrated into said aircraft's communication system without interfering with regular operation of aircraft communications.

36. The portable electronic voice recognition device in claim 35 is capable of being activated by a pre-programmed signal.

37. The portable electronic voice recognition device in claim 36 is capable of providing a pre-programmed output synthesized voice prompt in responding to an input voice prompt, said pre-programmed output synthesized voice prompt being different for different aircrafts.

38. The portable electronic voice recognition device in claim 37 waits for an input voice prompt before providing next pre-programmed output synthesized voice prompt.

39. The portable electronic voice recognition device in claim 38 is capable of functioning as a flight computer.
